(19) United States
(12) Patent Application Publication
(10) Pub. No.: US 2012/0089498 A1
(43) Pub. Date: Apr. 12, 2012

(54) Bail Bonds Agency Manager

(76) Inventors: Willy Hernando Salcedo, Houston, TX (US); Leopoldo Perrault Benitez, Missouri City, TX (US)

(21) Appl. No.: 13/267,751

(22) Filed: Oct. 6, 2011

Related U.S. Application Data
(60) Provisional application No. 61/390,477, filed on Oct. 6, 2010.

(51) Int. Cl. G06Q 50/26; G06Q 40/00

(52) U.S. Cl. 705/35

(57) ABSTRACT

Systems, methods, and computer-readable media having stored instructions for managing operations of a bail bond company are disclosed. A system includes one or more data storage devices which store a defendant module that includes one or more defendant profiles. Each defendant profile is associated with a defendant and includes information relating to each of one or more items of collateral that are associated with one or more bail bonds issued to the corresponding defendant. The data storage devices also include an administration module that is linked to the defendant module and that includes one or more administration sub-modules. The system further includes one or more client devices that communicate with the one or more data storage devices.

### CROSS-REFERENCE TO RELATED APPLICATION(S)

This application claims the benefit of U.S. Provisional Application No. 61/390,477, filed Oct. 6, 2010, the disclosure of which is hereby incorporated by reference in its entirety.

### BACKGROUND

A defendant arrested and arraigned for a crime has a constitutional right to have reasonable bail set by the presiding court depending on the nature and circumstances of the crime. Although a defendant is permitted to pay the full amount of the bail in order to obtain his/her release, often the defendant does not have the monetary means to do so. The United States is one of only two countries in the world with a justice system in which commercial bail bond companies are licensed to operate and play a significant role in whether a defendant is able to remain free while charges against the defendant are pending.

Commercial bail bond companies are typically licensed by a state agency to provide services to those who have been arrested and charged with the commission of a crime. Bail bond companies typically post a bond with the presiding court on behalf of a defendant in return for a non-refundable premium which is usually in the range of 10%-15% of the bail amount. The posting of the bond constitutes a guarantee on the part of the bail bond agency that the defendant will appear in court at a specified time(s) and place(s). If the defendant fails to appear in court, the bail bond company that posted the bond on the defendant's behalf will be responsible to the court for the full amount of the defendant's bail.

Bonds that are posted by bail bond companies are typically backed by credit providers. Credit providers issue surety bonds to bail bond companies that serve as financial backing for bail bonds issued by the company. Each surety bond is represented by a power—a legal instrument having a unique serial number and a monetary amount associated with it. Each bail bond posted by a bail bond company is backed by one or more powers. If a defendant fails to make a required court appearance, the bail bond company that posted the bond on the defendant's behalf and the credit provider that provided backing for the bond will both be obligated for the full amount of the bail. The credit provider typically makes payment to the presiding court for the full amount of the bail and then seeks to recoup its losses from the bail bond company.

### SUMMARY

A single bail bond company may have several offices located throughout one or more states. Each office may have as clients multiple defendants for whom bonds have been posted. Each office must be able to track information relating to each of the defendants associated with that office such as identifying information relating to each defendant, the number and amount of each bail bond issued for each defendant as well as the related case information, any collateral that has been offered by a defendant as backing for bail bonds issued for the defendant in the event that the defendant fails to make a required court appearance, and any payments received for premiums associated with bail bonds issued for each defendant. Certain administrator users at each office should also be able to track financial data relevant to that office, manage employee user accounts, track and manage issued bonds and corresponding powers, and maintain and manage office records. In addition, it is advantageous for multiple offices of a single bail bond company, and potentially, offices of different bail bond companies to be able to share information.

In accordance with one or more embodiments of the invention, a system for managing operations of a bail bond company is disclosed. The system comprises: one or more data storage devices and one or more client devices that are configured to communicate with the one or more data storage devices. The one or more data storage devices comprise: a defendant module that includes one or more defendant profiles, each of the one or more defendant profiles being associated with a defendant and at least one of the defendant profiles including information relating to each of one or more items of collateral that are associated with one or more bail bonds issued to the associated defendant, and an administration module linked to the defendant module, the administration module including one or more administration sub-modules.

In accordance with one or more embodiments of the invention, a method for managing operations of a bail bond company is disclosed. The method comprises: receiving identifying information relating to a prospective client, comparing the identifying information with information included in one or more defendant profiles stored on one or more data storage devices, retrieving and displaying a defendant profile of the one or more defendant profiles on one or more client devices in communication with the one or more data storage devices on the condition that the identifying information matches information in the defendant profile, and creating, and storing on at least a portion of the one or more data storage devices, a prospective client profile that includes the identifying information of the prospective client on the condition that the identifying information does not match a defendant profile of the one or more defendant profiles. In accordance with one or more embodiments of the invention, each of the one or more defendant profiles includes information relating to each of one or more items of collateral that are associated with one or more bail bonds issued to the corresponding defendant.

In accordance with one or more embodiments of the invention, a computer-readable medium storing a computer program including instructions for managing operations of a bail bond company is disclosed. Any combination of one or more computer readable media may be utilized. A computer readable medium may be a non-transitory computer readable medium, for example, but not limited to, an electronic, magnetic, optical, or semiconductor system, apparatus, or device, or any suitable combination of the foregoing. More specific examples (a non-exhaustive list) of non-transitory computer readable media include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. Program code embodied on a computer readable medium may be transmitted using any appropriate medium, including but not limited to wireless, wireline, optical fiber cable, RF, etc., or any suitable combination of the foregoing.

The stored instructions comprise instructions for: comparing identifying information received from a prospective client with information included in one or more defendant profiles stored on one or more data storage devices, retrieving and displaying a defendant profile of the one or more defendant profiles on one or more client devices in communication with the one or more data storage devices on the condition that the identifying information matches information in the defendant profile, and creating, and storing on at least a portion of the one or more data storage devices, a prospective client profile that includes the identifying information of the prospective client on the condition that the identifying information does not match a defendant profile of the one or more defendant profiles. In accordance with one or more embodiments of the invention, each of the one or more defendant profiles includes information relating to each of one or more items of collateral that are associated with one or more bail bonds issued to the corresponding defendant.

In accordance with one or more embodiments of the invention, a method for monitoring and tracking one or more items of collateral provided as backing for one or more bail bonds issued to a defendant is disclosed. The method comprises: receiving information relating to the one or more items of collateral from the defendant, inputting and storing the received information in one or more data storage devices, the one or more data storage devices including a defendant module that includes a defendant profile corresponding to the defendant, monitoring a status of the one or more items of collateral, and updating the information relating to the one or more items of collateral on the condition that a change in status of at least one of the one or more items of collateral occurs.

### BRIEF DESCRIPTION OF THE DRAWINGS

FIG. 1 shows a schematic of a system for managing operations of a bail bond company in accordance with one or more embodiments of the invention.

FIG. 2 shows a schematic of components of a system for managing operations of a bail bond company in accordance with one or more embodiments of the invention.

FIG. 3 shows a schematic of a dashboard in accordance with one or more embodiments of the invention.

FIG. 4 shows a flowchart illustrating a method in accordance with one or more embodiments of the invention.

FIG. 5 shows a flowchart illustrating a method in accordance with one or more embodiments of the invention.

### DETAILED DESCRIPTION

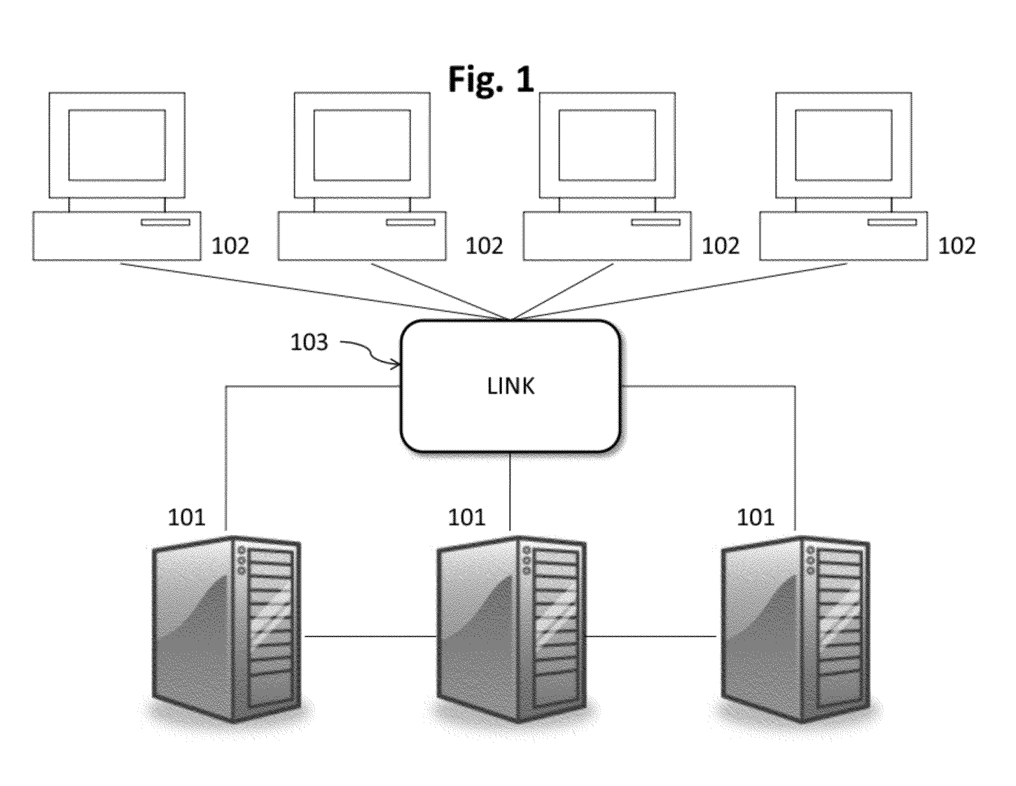

One or more embodiments of the invention relate to a system, method, and a computer-readable medium that stores instructions for managing operations of a bail bond company. FIG. 1 depicts a system for managing operations of a bail bond company in accordance with one or more embodiments of the invention. The system 100 comprises one or more data storage devices 101. One or more client devices 102 are configured to communicate with the one or more data storage devices 101 through a network link 103. The one or more client devices 102 are capable of requesting and retrieving information stored on the one or more data storage devices 101 through the network link 103.

In the context of the operations of a bail bond company having multiples offices or locations, the one or more data storage devices 101 may be physically located at a central location, for example, the main office or headquarters of the bail bond company. Alternatively, the one or more data storage devices 101 may be distributed among the various offices. For instance, one or more data storage devices 101 may be located at each office and may store information pertinent to that particular office. In other embodiments of the invention, information relevant to all offices of a bail bond company may be stored at a central location on one or more data storage devices 101 and information pertinent to each office may be accessed by client devices located at each office, or the information may be additionally stored on one or more data storage devices 101 located at each office. The one or more client devices 102 may be distributed throughout multiple offices or locations of a bail bond company.

In one or more alternative embodiments, the one or more data storage devices 101 may be located at an independent, third party location and owned and operated by the third party. The third party may itself be a bail bond company. One or more bail bond companies may purchase subscription services allowing the companies to store and access information relating to their operations on the data storage devices 101. The information stored on the data storage devices 101 may be partitioned in such a manner as to restrict a particular bail bond company's access to only that information that is pertinent to its operations. However, the data storage devices 101 may also store shared information that is designated as being accessible by a plurality of bail bond companies. An example of such shared information may include information relating to defendants who have failed to make a required court appearance. Allowing shared access to such information may provide bail bond companies with a broader geographical reach to locate such defendants. For example, bail bond companies may enter into fee arrangements with one another in exchange for assistance in locating missing defendants.

It will be appreciated by one or ordinary skill in the art that the one or more data storage devices 101 and the one or more client devices 102 may be networked or connected in any number of ways so as to allow the client devices 102 to retrieve information from the data storage devices 101 and share information among one another.

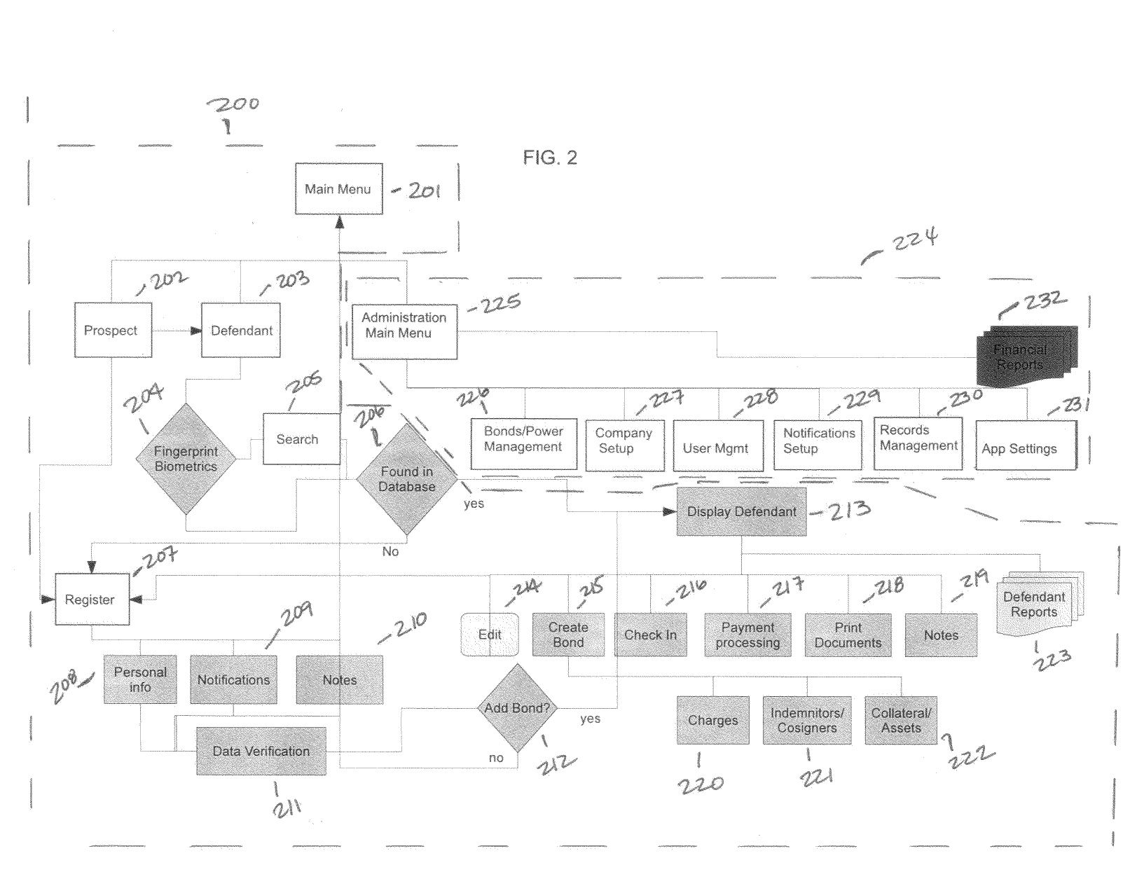

FIG. 2 depicts a schematic of components of a system for managing operations of a bail bond company in accordance with one or more embodiments of the invention. The various components shown in FIG. 2 may represent, for example, data modules and/or data sub-modules stored on the one or more data storage devices 101 and/or the one or more client devices 102 of the system. The one or more data storage devices 101 comprise a defendant module 200 and an administration module 224. According to some embodiments of the invention, the one or more data storage devices 101 located at a particular office may comprise a defendant module and an administration module that together comprise information relevant to that particular office. Alternatively, in those embodiments in which one or more data storage devices 101 are centrally located, the data storage devices 101 may comprise a defendant module and an administration module that store information relevant to all offices of the bail bond company, or multiple bail bond companies.

The defendant module may be accessed by basic users. Basic users may correspond to general employees of the bail bond company at each office location. However, portions of the defendant module, as will be discussed in more detail hereinafter, may be restricted and may be accessible only upon receipt of authorization. The administration module is generally only accessible by administrator users. The administration module may store sensitive information and the bail bond company's management and/or ownership may wish to preclude basic users from having access to such information. Both basic users and administrator users are at times referred to herein as system users.

Basic users and/or administrator users may access information stored on the data storage devices via an authenticated login process. Functionality may be provided that identifies the particular location from which a user is accessing the system. For example, when a user associated with a particular office location of a bail bond company accesses information stored on the data storage devices, the user's location may be automatically determined, thereby eliminating the need for the user to designate the bail bond company and/or office location with which he/she is associated.

Referring again to FIG. 2, the defendant module 200 comprises one or more defendant profiles 203. Each defendant profile 203 represents a data record that contains information relevant to a defendant for whom at least one bail bond has been issued by the bail bond company. Each of the defendant profiles 203 may comprise biometric information 204. The biometric information 204 may include fingerprint data, voice data, retinal scan data, photographs, video recordings, etc. The biometric information 204 assists in associating a particular individual with a particular defendant profile.

The defendant module 200 may also comprise profiles 202 corresponding to prospective clients. The term prospective client as used herein refers to an individual charged with a crime for which bail has been set and who is seeking the issuance of a bail bond from the bail bond company. If the bail bond company agrees to issue a bond for the prospective client, then the prospective client profile 202 associated with that prospective client may be converted to a defendant profile 203. Each of the prospective client profiles 202 and the defendant profiles 203 may have a numerical identifier associated therewith that uniquely identifies the particular prospective client or defendant. The numerical identifier associated with a particular defendant profile 203 or prospective client profile 202 may be used to link that profile to other information stored on the data storage devices that is relevant to that particular profile. For example, the numerical identifier that identifies a particular defendant or prospective client may be used to locate any co-signers associated with that individual, identify any collateral associated with bonds issued for that individual, etc.

The defendant module 200 also provides a search function 205. The search function 205 allows a system user to enter in various identifying information corresponding to an individual to determine whether the individual has a corresponding prospective client profile 202 or defendant profile 203 already stored on the data storage devices 101. If the search reveals a stored profile corresponding to the individual, the profile may be displayed to the system user through a “Display Defendant” screen 213. If, on the other hand, no profile corresponding to the individual is located through the search, a profile may be created for the individual through the registration sub-module 207. A prospective client profile 202 or a defendant profile 203 may be created.

Information may be entered and stored in the profile during creation of the profile. For example, personal information associated with the individual may be entered such as a home address, a work address, phone numbers, social security number, etc. Various notifications 209 and notes 210 may also be entered. Notifications 209 may specify various entities that should be notified on the condition that various events occur. For example, notifications 209 pertaining to a particular defendant may specify that the defendant's attorney should be notified of each required court appearance for the defendant a pre-specified period of time before the court appearance. The notes 210 associated with a particular profile may include any information that a system user believes is pertinent to the individual associated with the profile.

The system may be provided with an intelligent data entry capability that expedites the process by which information is entered into the system. For example, when entering an address for an individual, the system may automatically provide options for completing the address information. This information may be retrieved from a third party database, for example, the Google® Maps database. Moreover, information representing options for automatically completing information being entered into the data storage devices may be retrieved from third party databases or from information already stored on the data storage devices themselves.

After the personal information 208 is entered into a particular profile, the information may be subjected to a data verification process 211. As part of the data verification process 211, the personal information provided by an individual (prospective client or defendant) may be cross-checked with information stored in various other databases. For example, an address provided by an individual may be verified with the USPS database records to confirm that the address is valid. Similarly, other personal information provided by the individual such as a social security number may also be verified against information contained in various governmental databases. This data verification process 211 provides an extra layer of security to ensure that valid and accurate information is being provided by the individual and entered into the profile.

As part of this data verification process 211 or at any stage of use and operation, the system according to embodiments of the invention may be integrated with other systems that provide public databases. For example, the system may be linked to various third party websites that provide additional verification services or information. When creating a profile, a user may be provided with a listing of links to various websites that provide information that may assist in the data verification process. For example, the system user may be able to select a link that directs the user to a website that provides information regarding any outstanding warrants that have been issued for individuals sharing the same name as the individual for whom a profile is being generated. Alternately, one or more links may be provided that direct the system user to one or more third party websites that provide credit check information, address verification, social security verification, or any other publicly available or subscription-related information.

Agreements may be negotiated in advance with those websites that provide subscription services. It should be noted that the integration with third party systems need not be provided solely as part of the data verification process, and may be provided at any time during operation and use of the system. Further, in those embodiments in which multiple bail bond companies purchase subscriptions for access to a system according to embodiments of the invention, additional functionality, such as, for example, access to third party databases, may be provided by way of the addition of modules to the company's subscription.

A defendant profile or a prospective client profile may also be populated with information that is already stored on the one or more data storage devices. For example, if a defendant or prospective client profile is being created for an individual who is, for example, a co-signer or a contact for another defendant, then the information associated with that individual may be used to automatically populate information fields in the newly created profile. As such, the amount of time and expense associated with the creation of profiles for individuals for whom stored information already exists may be significantly reduced.

Upon completion of the creation of a prospective client profile 202, the system user may return to the main menu 201. Upon completion of the creation of a defendant profile 203, the system user may be prompted to specify whether the user wishes to associate a bail bond with the newly created profile. If the user does not presently wish to add a bail bond to the profile, the user may be re-directed back to the main menu 201. However, if the system user does wish to associate a bail bond with a defendant profile, the system user may be directed to a “Display Defendant” screen 213.

From the “Display Defendant” screen, a system user may view a defendant profile and information associated with the defendant. For example, a system user may view all outstanding bail bonds that have been issued for the defendant who is associated with the defendant profile. Further, a system user may view any collateral or co-signers that are associated with the issued bail bonds.

A system user is also presented with the option of creating a new bail bond and associating the bail bond with the defendant profile. Prior to creating a new bail bond through the create bond module 215, the user may be presented with various alerts indicating the risks associated with issuing a bond for the defendant. For example, the system user may be presented with an alert indicating that several bonds have previously been issued for the same defendant, or an alert that indicates that the amount of outstanding bail bonds issued for the defendant exceeds a certain threshold amount.

The bail bond company may have a protocol in place that specifies certain conditions under which a bail bond: 1) should not be issued, 2) may be issued, or 3) may be issued only after obtaining authorization from someone having the authority to issue such an authorization. Depending on the type and nature of the alerts and the particular protocol that is in place, the system user may be able to immediately create the bond or deny the bond. Alternatively, the system user may need to obtain authorization to create the bond. In one or more embodiments of the invention, the system may automatically grant or deny the bond based on the particular protocol that is in place.

Upon creating a bond through the create bond module 215, the particular charges 220 associated with the bail bond may be specified. In addition, any indemnitors or co-signers 221 liable for the bond amount in the event that the defendant fails to make required court appearances may also be specified. Further, any collateral or assets 222 provided by the defendant as backing for the issued bond may also be specified. The information provided relating to collateral will be described in more detail hereinafter.

The defendant profile may also include a check-in sub-module 216 in which dates/times for the defendant to contact the bail bond company may be specified. The system user may be presented with the option of specifying a schedule for the defendant to periodically contact the bail bond company to ensure that the defendant has not fled and will make all required court appearances. The defendant may be provided with an identification card which the defendant may use to contact the bail bond company. For example, the identification card may have a unique numerical identifier associated with the defendant printed thereon. The defendant may then check-in with the bail bond company through an integrated voice response (IVR) system capable of detecting voice and dual-tone multi-frequency signaling (DTMF) keypad inputs. For example, the defendant may be required to enter or say the numerical identifier associated with the defendant, and may be further required to provide additional voice inputs for identity confirmation. The frequency with which the defendant must periodically contact the bail bond company may be determined based on a multitude of factors that together provide an assessment of the risk that the defendant may fail to make a required court appearance. In addition, the amount and extent of additional voice verification that a defendant must provide through the IVR system may also be determined based on an assessment of the risk that the defendant may fail to make a required court appearance.

The defendant profile may further include a payments sub-module 207 that provides information relating to payments received with respect to the bail bonds associated with the defendant. Through the payments sub-module 207, a system user may be provided with the ability to accept electronic payments by means of a credit card, automatic bank draft, online payment service providers such as Paypal, etc. An encrypted copy of a credit card number provided by a defendant may also be maintained so as to allow for future automatic charges. Defendants or those individuals providing payment with respect to a bail bond may be provided with an email confirmation of payment.

Whether a particular type of payment will be accepted for a bail bond issued for a particular defendant may be based on the risk assessment associated with that defendant. For example, a payment by check may be accepted only when the risk assessment associated with the defendant is below a certain threshold. The risk assessment associated with a particular defendant may be a quantitative measure of the risk that the defendant may fail to make a required court appearance and that the bail bond company may become liable for the full amount of the bail. The risk assessment may be based on one or more parameters that may be combined formulaically to arrive at the risk assessment. In addition, the ability to authorize acceptance of certain forms of payment for a bail bond associated with a defendant, or to issue a refund for an over-payment, may be restricted to specific administrator users.

In a defendant profile, a module 218 may also be provided for printing documents. All documents relating to a defendant and the bail bonds associated with that defendant may be scanned and stored in the defendant profile. In this manner, a virtually paperless office may be maintained. The scanned documents may be printed if necessary. The scanned documents may also be subjected to an OCR process so that the text of the documents is searchable. In addition, any notes 219 that a system user deems relevant to a particular defendant profile may be entered in the profile.

A system user may also have the permission to edit a defendant profile through the edit sub-module 214. Generally, the capability to edit a defendant profile will be restricted to office managers or other employees having a supervisory capacity. A basic user will generally not have the authorization to edit pre-existing records in a defendant profile. The ability to create defendant reports 223 will also generally be restricted to particular users. The defendant reports may include more sensitive information regarding a defendant that basic users are restricted from accessing and that is only available to office managers or other authorized employees.

The administration module 224 includes various administration sub-modules. The administration module 224 includes an administration main menu 225 from which various administration sub-modules may be accessed. The bonds/power management sub-module 226 allows an administrator user to view and manage all currently outstanding and former bonds as well as the powers associated with the bonds. Through the bonds/power management sub-module 226, an administrator user may also generate various tabular and graphical data according to various specified parameters. For example, an administrator user may generate a bar graph demonstrating the total dollar amount of bail bonds issued for each month over a specified period of time (e.g. one year). By way of another example, an administrator user may generate tabular or graphical data depicting the number and dollar amount of bail bonds issued for a particular defendant over a given period of time. One of ordinary skill in the art will appreciate that numerous other parameters may be viewed in tabular, graphical, or other forms through the bonds/power management sub-module 226.

The administration module 224 also includes a company setup sub-module 227, a user management sub-module 228, a notifications setup sub-module 229, a records maintenance sub-module 230, an applications settings sub-module 231, and a financial reports sub-module 232. The company setup sub-module 227 allows an administrator user to access and edit information relating to one or more offices of the bail bond company such as office/company protocol. The user management sub-module 228 allows an administrator user to manage and access various user accounts. Through sub-module 228, an administrator user may alter a user's access privileges, monitor a user's production, etc. The notifications setup sub-module 229 permits an administrator user to manage and edit the type and manner in which notifications relevant to one or more defendants are disseminated to various users and/or third parties. For example, an administrator user may designate that whenever a bail bond is issued that exceeds a certain amount, the credit provider(s) that issued the power(s) must be notified of all court appearances for the defendant associated with the issued bail bond.

The records maintenance sub-module 230 allows an administrator user to manage, for example, financial records of the bail bond office or information contained in the defendant or prospective client profiles. The application settings sub-module 231 allows an administrator user to manage, edit, and access application settings that affect, for example, the manner in which various content is provided to the user. The financial reports sub-module 232 permits an administrator user to, for example, view financial data that pertains to one or more offices of the bail bond company.

It should be noted that an administrator user has the authority to access both the administration module 224 and the defendant module 200. Further, in one or more embodiments of the invention, a basic user at any of the offices may access the defendant modules 200 for each of the offices of the bail bond company. In addition, in one or more embodiments of the invention, an administrator user at any of the offices may access the administration module 224 at each of the offices of the bail bond company. Further, in one or more embodiments of the invention, one or more central data storage devices may comprise a central administration module that includes data that pertains to multiple offices of one or more bail bond companies and a central defendant module that includes defendant profiles and prospective client profiles for all defendants and prospective clients associated with multiple offices of one or more bail bond companies. One or more global users may have access to the central data storage devices, and may thereby access the central defendant module and the central administration module.

As previously discussed, each defendant profile may include information relating to each of one or more items of collateral that are associated with one or more bail bonds issued for the defendant associated with the defendant profile. The information relating to the items of collateral may include information relating to one or more parameters associated with the each item of collateral. The one or more parameters may include, for example, a parameter representing a valuation of the item of collateral, a parameter representing a type of the collateral; and a parameter indicating a lien status of the item of collateral. Pre-defined fields may be provided in a defendant profile for inputting information corresponding to the various parameters. Further, the pre-defined fields may be associated with the type of collateral being specified. For example, if the collateral is a vehicle, pre-defined fields may be provided to a user for inputting a make and model of the vehicle, a VIN number, a general description of the vehicle, etc.

In addition, according to one or more embodiments of the invention, a bond score may be generated for the defendant based on the information relating to the parameter(s) associated with each item of collateral. The bond score may then be used to determine whether to issue a new bail bond for the defendant. For example, if multiple bail bonds have been previously issued for a defendant and the amount of collateral offered by the defendant for those bail bonds is minimal, the defendant may be given a relatively low bond score which would negatively impact the defendant's ability to obtain additional bail bonds. Further, if the bail bond company has become liable for the full amount of one or more bail bonds for the defendant as a result of the defendant failing to fulfill all obligations associated with his release, the defendant's bond score may be so low as to place the score below of a minimum threshold necessary to be considered for a bail bond. The bond score assigned to a defendant may be a similar measurement or the same as the risk assessment previously discussed. In those embodiments of the invention in which the bond score and the risk assessment represent different measures of risk associated with the defendant, one or both of these measurements may be used to determine whether a bail bond will be issued to a defendant.

According to one or more embodiments of the invention, a dashboard may be presented to a system user upon accessing the system. As an example, the dashboard may be presented to the user as part of the main menu 201 (FIG. 2) upon accessing the defendant module 200. Further, the dashboard may remain available to the user as the user navigates through various sub-modules of the system.

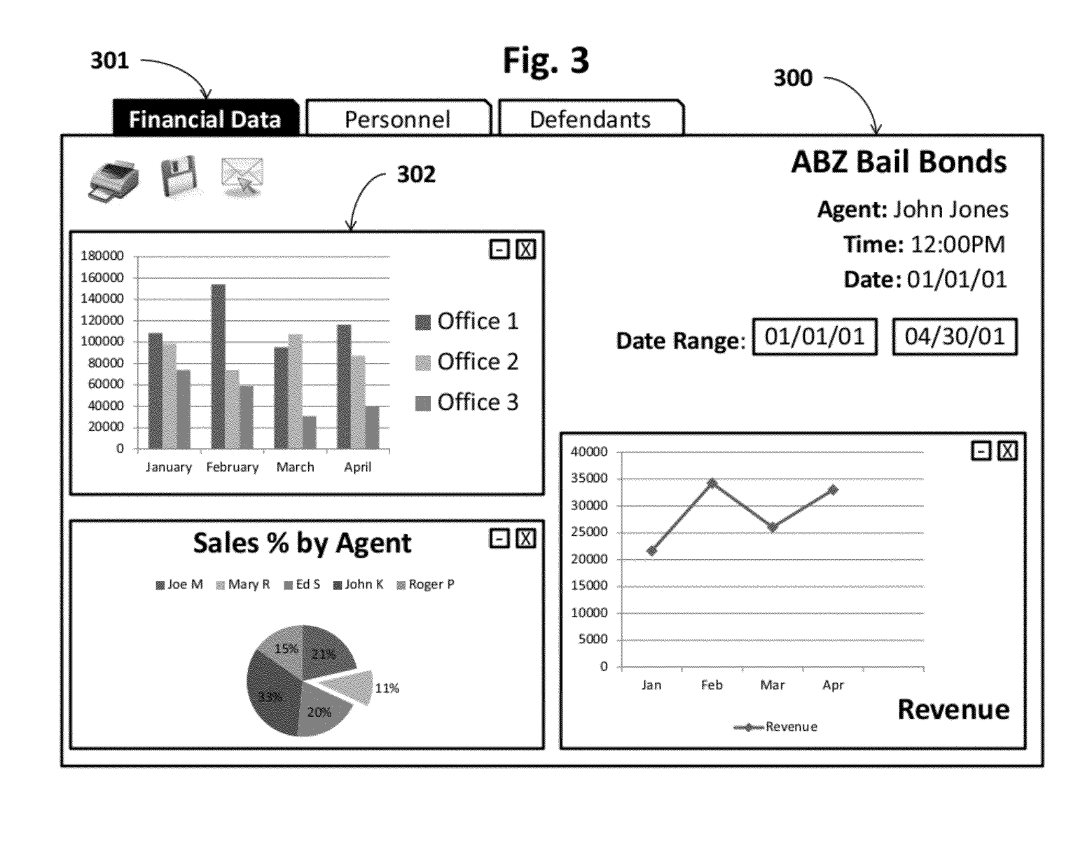

FIG. 3 depicts a schematic of an exemplary dashboard. The dashboard 300 includes tabs 301. Each tab 301 may correspond to a different category of information. For example, a tab 301 may relate to financial data. Upon clicking on a tab 301, the tab 301 expands to display a window having a plurality of sub-windows 302. Each sub-window may be independently minimizable. Each sub-window 302 may correspond to a specific sub-category of information that falls within the broader category defined by the tab 301. For example, if a tab 301 corresponds to financial data, a sub-window 302 within that tab may display incoming and outgoing payments for one or more offices of the bail bond company over a given period of time. As another example, a tab 301 may correspond to bail bond data. A sub-window 302 within a bail bond data tab may provide information relating to the largest outstanding bail bonds issued by one or more offices. The information may include the defendants for whom the bail bonds were issued, the remaining court appearances required for each of the associated defendants, whether each defendant has complied with the check-in policy instituted for that defendant, etc. One of ordinary skill in the art will appreciate that the tabs 301 and sub-windows 302 may correspond to a myriad of different categories and sub-categories of information.

In one or more embodiments of the invention, the information provided in the dashboard may be customizable by a particular user. For example, a user may be given the option of selecting from tabs relating to a pre-defined number of categories, or a user may be able to define individualized tabs. Further, a user may be provided the option of customizing the type of information provided in sub-windows of a particular tab. For example, a user may decide that the financial data tab should be displayed initially upon accessing the system and that all of the sub-windows initially displayed in that tab should graphically display the productivity of each employee at a particular office over the course of a month. In addition, the dashboards may be customizable in relation to the type of user accessing the system. For example, an administrator user may be able to select from a broader set of categories and sub-categories of information for the tabs and sub-windows of his/her dashboard as compared to a basic user.

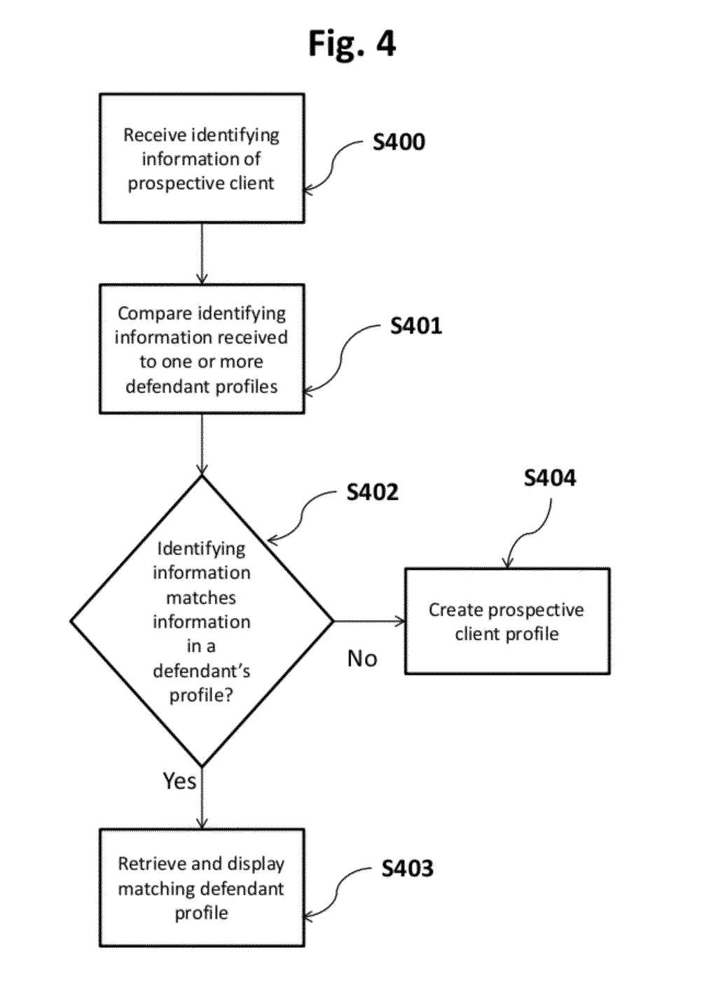

FIG. 4 depicts a flowchart illustrating a method in accordance with one or more embodiments of the invention. In step S400 of the method, identifying information relating to a prospective client is received. The identifying information may include a name, contact numbers, addresses, social security number, etc. Then, in step S401, the identifying information is compared with information included in one or more defendant profiles stored on one or more data storage devices. Thereafter, in step S402, a determination is made as to whether the identifying information received matches the information included in a defendant profile of the one or more defendant profiles. In step S402, if it is determined that the identifying information matches information in a defendant profile, the defendant profile is retrieved and displayed to a user in step S403. On the other hand, if in step S402, it is determined that the identifying information does not match a defendant profile of the one or more defendant profiles, a prospective client profile is created and stored on the one or more data storage devices in step S404. The prospective client profile includes at least the identifying information provided by the prospective client.

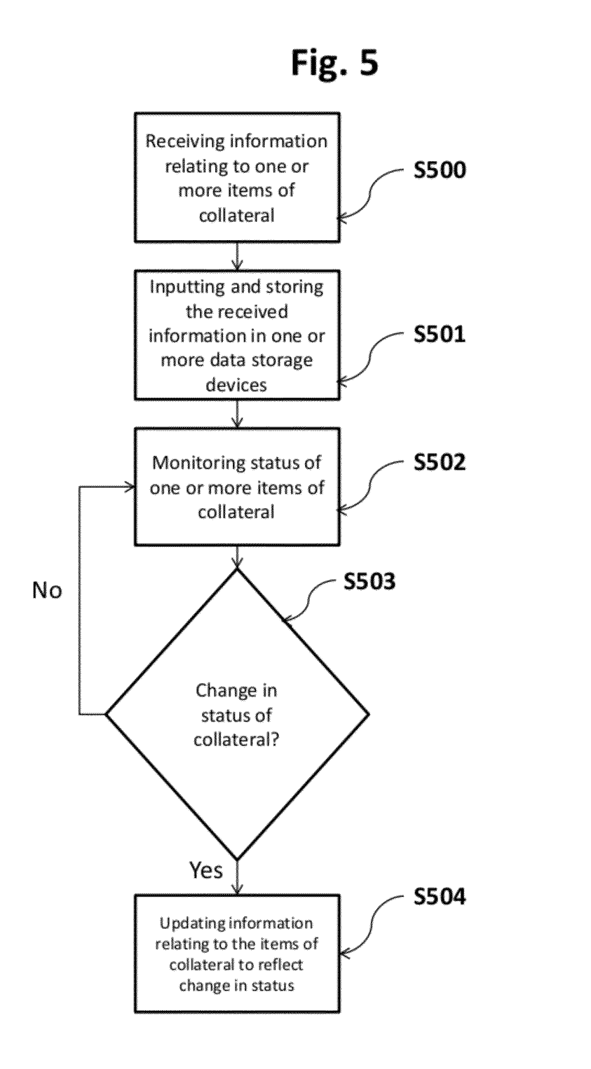

FIG. 5 depicts a flowchart illustrating a method for monitoring and tracking one or more items of collateral provided as backing for one or more bail bonds issued to a defendant in accordance with an embodiment of the invention. In step S500 of the method, information relating to the one or more items of collateral is received from the defendant. In step S501, the received information is inputted and stored in one or more data storage devices. The one or more data storage devices may include a defendant module that includes a defendant profile corresponding to the defendant. Then, in step S502, a status of the collateral is monitored. The term status may refer to any aspect of the collateral including, but not limited to, the valuation of the collateral, a lien status of the collateral, a location of the collateral, etc. In step S503, a determination is made as to whether the status of the collateral has changed. If it is determined that the status of the collateral has changed, then in step S504, the information relating to the one or more items of collateral is updated to reflect the change in the status. On the other hand, if it is determined that the status of the collateral has not changed, then periodic monitoring of the status of the collateral is performed.

It should be noted that in one or more of the previously disclosed embodiments, the information stored on the one or more data storage devices may be accessible from mobile devices through cellular networks, WiFi networks, etc. Additional authorization may be required to access the system from mobile devices in order to ensure added layers of security.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What is claimed is:

1. A system for managing operations of a bail bond company, the system comprising:
one or more data storage devices comprising:
a defendant module that comprises one or more defendant profiles, at least one of the one or more defendant profiles being associated with a defendant and comprising information relating to each of one or more items of collateral that are associated with one or more bail bonds issued to the corresponding defendant; and
an administration module linked to the defendant module, the administration module including one or more administration sub-modules; and
one or more client devices that communicate with the one or more data storage devices.

2. The system of claim 1, wherein the information relating to each item of collateral includes information relating to one or more parameters associated with the item of collateral.

3. The system of claim 2, wherein a bond score is generated for the defendant based on the information relating to the one or more parameters.

4. The system of claim 2, wherein the one or more parameters include at least one of:
a parameter representing a valuation of the item of collateral;
a parameter representing a type of the item of collateral; and
a parameter indicating a lien status of the item of collateral.

5. The system of claim 1, wherein each defendant profile further comprises:
identifying information relating to the corresponding defendant;
notification information relating to the corresponding defendant; and
information relating to at least one of an indemnitor and a co-signer associated with the corresponding defendant.

6. The system of claim 5, wherein the identifying information relating to the corresponding defendant comprises:
personal biographical and address information; and
biometric information.

7. The system of claim 1, further comprising:
a user interface provided on each of the one or more client devices through which one or more users access the one or more data storage devices, wherein access to the administration module is restricted to a designated number of administrator users of the one or more users.

8. The system of claim 7, wherein the user interface comprises a dashboard that comprises:
one or more tabs, each tab defining at least one category of information, the at least one category of information comprising at least one of a user-specified category of information and a pre-defined category of information,
wherein:
each tab comprises one or more sub-windows, and
each sub-window relates to at least one sub-category of information, and
the at least one sub-category of information comprises at least one of a user-specified sub-category of information and a pre-defined sub-category of information, and corresponds to at least one category of information defined by at least one tab.

9. The system of claim 1, wherein the one or more data storage devices further comprise:
a prospective client module that includes one or more prospective client profiles, each prospective client profile corresponding to a prospective client.

10. The system of claim 9, wherein a prospective client profile is converted to a defendant profile on the condition that the prospective client that corresponds to the prospective client profile is accepted as a client of the bail bond company.

11. The system of claim 1, wherein the one or more administration sub-modules comprises at least one of:
a bail bonds management module;
a user management module;
a notifications module;
a records maintenance module;
a financial reports module; and
an application settings module.

12. A method for managing operations of a bail bond company, the method comprising:
receiving identifying information relating to a prospective client;
comparing the identifying information with information included in one or more defendant profiles stored on one or more data storage devices;
retrieving and displaying a defendant profile of the one of more defendant profiles on one or more client devices in communication with the one or more data storage devices on the condition that the identifying information matches information in the defendant profile, the defendant profile including:
information relating to each of one or more items of collateral that are associated with one or more bail bonds issued to the corresponding defendant; and
creating, and storing on at least a portion of the one or more data storage devices, a prospective client profile that includes the identifying information of the prospective client on the condition that the identifying information does not match a defendant profile of the one or more defendant profiles.

13. A non-transitory computer-readable medium storing a computer program including instructions for managing operations of a bail bond company, the instructions comprising:
comparing identifying information received from a prospective client with information included in one or more defendant profiles stored on one or more data storage devices;
retrieving and displaying a defendant profile of the one or more defendant profiles on one or more client devices in communication with the one or more data storage devices on the condition that the identifying information matches information in the defendant profile, the defendant profile including:
information relating to each of one or more items of collateral that are associated with one or more bail bonds issued to the corresponding defendant; and
creating, and storing on at least a portion of the one or more data storage devices, a prospective client profile that includes the identifying information of the prospective client on the condition that the identifying information does not match a defendant profile of the one or more defendant profiles.

14. The computer-readable medium of claim 13, wherein the information relating to each item of collateral includes information corresponding to one or more parameters relating to the item of collateral.

15. The computer-readable medium of claim 14, wherein the one or more parameters include at least one of:
a parameter representing a valuation of the item of collateral;
a parameter representing a type of the item of collateral; and
a parameter indicating a lien status of the item of collateral.

16. The computer-readable medium of claim 13, wherein each defendant profile further comprises:
identifying information relating to the corresponding defendant;
notification information relating to the corresponding defendant; and
information relating to at least one of an indemnitor and a co-signer associated with the corresponding defendant.

17. The computer-readable medium of claim 13, wherein:
the one or more data storage devices form at least part of a server with which the computer-readable medium communicates and the server is accessed by one or more users through a user interface provided on each of one or more client devices, and
the one or more data storage devices further include:
a defendant module comprising the one or more defendant profiles; and
an administration module linked to the defendant module, the administration module including one or more administration sub-modules, wherein access to the administration module is restricted to a designated number of administrator users of the one or more users.

18. The computer-readable medium of claim 16, wherein the identifying information comprises:
personal biographical and address information; and
biometric information.

19. The computer-readable medium of claim 17, wherein the user interface comprises a dashboard that comprises:
one or more tabs, each tab defining at least one category of information, the at least one category of information comprising at least one of a user-specified category of information and a pre-defined category of information,
wherein:
each tab comprises one or more sub-windows, and
each sub-window relates to at least one sub-category of information, the at least one sub-category of information comprising at least one of a user-specified sub-category of information and pre-defined sub-category of information, and corresponds to at least one category of information defined by at least one tab.

20. A method for monitoring and tracking one or more items of collateral provided as backing for one or more bail bonds issued to a defendant, the method comprising:
receiving information relating to the one or more items of collateral from the defendant;
inputting and storing the received information in the one or more data storage devices of the system of claim 1;
monitoring a status of the one or more items of collateral; and
updating the information relating to the one or more items of collateral on the condition that a change in status of at least one of the one or more items of collateral occurs.
